(19) United States
(12) Patent Application Publication
(10) Pub. No.: US 2026/0343563 A1
(43) Pub. Date: Oct. 29, 2026

(54) First User Equipment, Network Node and Methods for Enabling Sidelink in a Wireless Communication Network

(71) Applicant: Telefonaktiebolaget LM Ericsson (PUBL), Stockholm (SE)

(72) Inventors: Min Wang, Luleå (SE); Antonino Orsino, KIRKKONUMMI (FI)

(21) Appl. No.: 18/704,144

(22) PCT Filed: Oct. 26, 2022
(86) PCT No.: PCT/SE2022/050977

§ 371 Date: Apr. 24, 2024

Related U.S. Application Data
(60) Provisional application No. 63/263,238, filed on Oct. 29, 2021.

(51) Int. Cl. H04W 72/25; H04W 36/00

(52) U.S. Cl. CPC H04W 72/25; H04W 36/00692

(57) ABSTRACT

Embodiments herein may relate to a method performed by a first UE (10) for handling communication over a sidelink in a wireless communication network. The first UE receives a configuration from a network node to setup carrier aggregation over multiple carriers of a SL to a second UE (13). The first UE further selects one of the multiple carriers, in the received configuration, to establish a primary carrier connection between the first UE (10) and the second UE (13) for handling control signalling messages, and one or more of the multiple carriers as a secondary carrier connection between the first UE (10) and the second UE (13) for handling messages other than control signalling messages.

### TECHNICAL FIELD

Embodiments herein relate to a first user equipment (UE), a network node and methods performed therein regarding wireless communication. Furthermore, a computer program product and a computer-readable storage medium are also provided herein. Especially, embodiments herein relate to handling or enabling communication, e.g. handling sidelink (SL) communication between UEs, in a wireless communication network.

### BACKGROUND

In a typical wireless communication network, UEs, also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the wireless devices within range of the access node. The radio network node communicates over a downlink (DL) to the wireless device and the wireless device communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more CNs.

Specifications for the Evolved Packet System (EPS) have been completed within the 3^{rd} Generation Partnership Project (3GPP) and this work continues in the coming 3GPP releases, such as fifth generation (5G) and sixth generation (6G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more CNs.

With the emerging 5G technologies also known as new radio (NR), the use of very many transmit- and receive-antenna elements may utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

SL transmissions are direct communications between two UEs without signal relay through a base station. Such SL communication is illustrated in FIG. 1. SL transmissions over NR are specified for release (Rel.)-16 allowing direct communication between two UEs without going through a base station. The NR SL is an evolution of the LTE SL, in particular of the features introduced in release (Rel)-14 and Rel-15 for vehicle to everything (V2X) communication. Some of the most relevant features of the NR SL are the following:
Support for unicast and groupcast transmissions, in addition to broadcast transmissions, which were already supported in LTE.
Support for hybrid automatic repeat request (HARQ) feedback over the SL for unicast and groupcast. This feedback is conveyed by the receiver UE to the transmitter UE using the physical sidelink feedback channel (PSFCH). This functionality is new in NR compared to LTE.
To alleviate resource collisions among different SL transmissions launched by different UEs, it enhances channel sensing and resource selection procedures, which also lead to a new design of physical channels carrying sidelink control information (SCI). The new design of the SCI simplifies coexistence between releases by grouping together all the information related to resource allocation, which is critical for coexistence, in a single channel with a robust, predefined format. Other control information is carried by other means, in a more flexible manner.
Grant-free transmissions, which are supported in NR uplink transmissions, are also provided in NR SL transmissions, to improve the latency performance.
To achieve a high connection density, congestion control and thus the quality of service (QOS) management is supported in NR SL transmissions.

### NR SL Physical Channels

In NR SL, the following physical layer (PHY) channels are defined:
Physical Sidelink Common Control Channel (PSCCH): This channel carries SCI including part of the scheduling assignment (SA) that allows a receiver to further process and decode the corresponding Physical Sidelink Shared Channel (PSSCH), e.g., demodulation reference signal (DMRS) pattern and antenna port, modulation and coding scheme (MCS), etc. In addition, the PSCCH indicates future reserved resources. This allows a receiver (RX) to sense and predict the utilization of the channel in the future. This sensing information is used for the purpose of UE-autonomous resource allocation, Mode 2, which is described below.
PSSCH: The PSSCH is transmitted by a SL transmitter UE, which conveys SL transmission data, i.e., the SL shared channel (SL-SCH), and a part of the SCI. In addition, higher layer control information may be carried using the PSSCH, e.g., medium access control (MAC) control elements (CE), radio resource control (RRC) signalling, etc.. For example, channel state information (CSI) is carried in the MAC CE over the PSSCH instead of the PSFCH.
PSFCH: The PSFCH is transmitted by a SL receiver UE for unicast and groupcast. It conveys the SL HARQ acknowledgement, which may consist of acknowledgement (ACK) and/or negative acknowledgement (NACK), used for unicast and groupcast option 2, or NACK-only, used for groupcast option 1.
Physical Sidelink Broadcast Channel (PSBCH): The PSBCH conveys information related to synchronization, such as the direct frame number (DFN), indication of the slot and symbol level time resources for SL transmissions, in-coverage indicator, etc. The synchronization signal block (SSB) is transmitted periodically at every 160 ms. The PSBCH is transmitted along with the sidelink primary synchronization signal (S-PSS) or sidelink secondary synchronization signal (S-SSS) as a sidelink synchronization signal block (S-SSB).
   S-PSS/S-SSS are used by UEs to establish a common timing reference among UEs in the absence of another reference such as global navigation satellite system (GNSS) time of network (NW) time.

Along with the different physical channels, reference signals (RS) are transmitted for different purposes, including demodulation (DM-RS), phase tracking RS (PT-RS), or RS for channel state information acquisition such as channel state information reference signal (CSI-RS).

Another new feature is the two-stage SCI. This a version of a downlink control information (DCI) for SL. A first part, such as a first stage, of the SCI is sent on the PSCCH. This part is used for channel sensing purposes, including the reserved time-frequency resources for transmissions, DMRS pattern and antenna port, etc., and can be read by all UEs while the remaining part, such as a second stage, of the SCI carries the remaining scheduling and control information such as a 8-bits source identity (ID) and a 16-bits destination ID, New Data Indicator (NDI), redundancy version (RV) and HARQ process ID, is sent on the PSSCH to be decoded by the receiver UE.

NR SL supports the following two modes of resource allocation:
Mode 1: SL resources are scheduled by a gNB.
Mode 2: The UE autonomously selects SL resources from a (pre-)configured SL resource pool(s). To avoid collisions between UEs a procedure based on the channel sensing and resource reservation is used.

An in-coverage UE may be configured by a gNB to use Mode 1 or Mode 2. For the out-of-coverage UEs, only Mode 2 may be used.

Like in LTE, scheduling over the SL in NR is performed in different ways for Mode 1 and Mode 2.

In Mode 1, the grant is provided by the gNB. The following two kinds of grants are supported:

Dynamic grants are provided for one or multiple transmissions of a single packet, i.e., transport block (TB). When the traffic to be sent over SL arrives at a transmitter UE, i.e., at the corresponding transmitter (TX) buffer, the UE initiates a four-message exchange procedure to request SL resources from a gNB; scheduling request (SR) on UL, grant, buffer status report (BSR) on UL, and grant for data on SL sent to UE. A gNB indicates the resource allocation for the PSCCH and the PSSCH in the DCI conveyed by PDCCH with cyclic redundancy check (CRC) scrambled with the SL radio network temporary identifier (SL-RNTI) of the corresponding UE. A UE receiving such a DCI, assumes that it has been provided a SL dynamic grant only if the detects that the CRC of DCI has been scrambled with its SL-RNTI. The transmitter UE then indicates the time-frequency resources and the transmission scheme of the allocated PSSCH in the PSCCH, and launches the PSCCH and the PSSCH on the allocated resources for SL transmissions. When a grant is obtained from the gNB, the transmitter UE can only transmit a single TB. As a result, this kind of grant is suitable for traffic with a loose latency requirement.

Configured grant: For the traffic with a strict latency requirement, performing the four-message exchange procedure to request SL resources may induce unacceptable latency. In this case, prior to the traffic arrival, the transmitter UE may perform the four-message exchange procedure and request a set of resources. If a grant can be obtained from the gNB, then the requested resources are reserved in a periodic manner. Upon traffic arriving at the transmitter UE, this UE can launch the PSCCH and the PSSCH on the upcoming resource occasion. In fact, this kind of grant is also known as grant-free transmissions.

Note that only the transmitter UE is scheduled by the gNB. The receiver UE does not receive any information directly from the gNB. Instead, it is scheduled by the transmitter UE by means of the SCI. Therefore, a receiver UE should perform blind decoding to identify the presence of PSCCH and find the resources for the PSSCH through the SCI.

In Mode 2 resource allocation, the grant is generated by the UE itself. When traffic arrives at a transmitter UE, i.e., at the corresponding TX buffer, this transmitter autonomously selects resources for the PSCCH and the PSSCH. To further enhance the probability of successful TB decoding at one shot and thus suppress the probability to perform retransmissions, a transmitter UE may repeat the TB transmission along with the initial TB transmission. These retransmissions may be triggered by the corresponding SL HARQ feedback or may be sent blindly by the transmitter UE. In either case, to minimize the probability of collision for potential retransmissions, the transmitter UE may also reserve the corresponding resources for PSCCH/PSSCH for retransmissions. That is, the transmitter UE selects resources for:
1) The PSCCH/PSSCH corresponding to the first transmission.
2) The PSCCH/PSCCH corresponding to the retransmissions. Resources for up to 2 retransmissions may be reserved. These reserved resources are always used in case of blind retransmissions. If SL HARQ feedback is used, the usage of the reserved resources is conditional on a negative SL HARQ acknowledgement.

Since each transmitter UE in SL transmissions should autonomously select resources for its own transmissions, preventing the different transmitter UEs from selecting the same resources turns out to be a critical issue in Mode 2. A particular resource selection procedure is therefore imposed to Mode 2 based on channel sensing. The channel sensing algorithm involves detecting the reservations transmitted by other UEs and performing power measurements, i.e., reference signal received power (RSRP), on the incoming transmissions.

### HARQ-Based SL RLF Detection

As described in clause 5.22.1.3.3 of TS 38.321 V 16.6.0, the HARQ-based SL radio link failure (RLF) detection procedure is used to detect SL RLF based on a number of consecutive discontinuous transmission (DTX) on PSFCH reception occasions for a PC5-radio resource control (RRC) connection.

RRC configures the following parameter to control HARQ-based SL RLF detection:
sl-maxNumConsecutiveDTX.

The following UE variable is used for HARQ-based SL RLF detection.
numConsecutiveDTX, which is maintained for each PC5-RRC connection.

The SL HARQ Entity shall (re-)initialize numConsecutiveDTX to zero for each PC5-RRC connection which has been established by upper layers, if any, upon establishment of the PC5-RRC connection or (re)configuration of sl-maxNumConsecutiveDTX.

The SL HARQ Entity shall for each PSFCH reception occasion associated to the PSSCH transmission:
1> if PSFCH reception is absent on the PSFCH reception occasion:
2> increment numConsecutiveDTX by 1;
2> if numConsecutiveDTX reaches sl-maxNumConsecutiveDTX:
3> indicate HARQ-based Sidelink RLF detection to RRC.
1> else:
2> re-initialize numConsecutiveDTX to zero.

### SUMMARY

As part of developing embodiments herein, one or more problems were first identified for the above actions:

In 3GPP, carrier aggregation (CA) is being proposed by companies for ReL-18 SL topics. It is most likely to be agreed by 3GPP as one Rel-18 topic.

In Uu CA, at least a primary cell (PCell) and one (or more) Secondary cells (SCell) are linked to two different carriers. Further, the UE performs radio link monitoring (RLM) only on the PCell since this carrier is the only one that needs to have a DL and UL carrier. For the SCell instead, the network is mandate to configure a DL carrier whereas the UL carrier is optional and is configured only in certain condition(s).

However, for the UE configured with SL CA, situation is different. For each SL carrier, transmission is bidirectional. There is no concept of UL or DL but only a SL carrier where both SL UEs can transmit in a scheduled way. Along these lines the framework that exist for NR CA cannot be directly applied for SL CA as there is no real difference between PCell and SCell. These cells are in fact the same from a protocol point of view. Still, for SL CA, different roles of SL carriers may need to be defined since the following need to be considered:
Among of all configured SL carriers, only one carrier may be selected to carry PC5-RRC connection, while other SL carriers may be used to transmit data.
For a SL UE configured with SL CA, how to maintain SL carriers in case the UE moves around.
How the UE handles a carrier if the UE has moved out coverage area of the carrier.
How the UE handle a new carrier if the UE has moved in coverage area of the carrier.
How the UE handle the configuration of a carrier if the measured channel quality of the carrier shows a big change.

Therefore, it is necessary to study how to address the above issues and develop corresponding solutions.

An object of embodiments herein is, thus, to provide a mechanism that handle communication between UEs efficiently in the wireless communication network.

According to an aspect, the object is achieved by providing a method performed by a first UE, such as a device to device UE, for handling communication over a SL in a wireless communication network. The first UE receives a configuration from a network node to setup carrier aggregation over multiple carriers to a second UE. The configuration may comprise information for setting up multiple carriers that may or not may be used at the same time. One of the multiple carriers is selected to establish a primary carrier connection between the first UE and a second UE for handling control signalling messages, and one or more of the multiple carriers is selected as a secondary carrier connection between the first UE and the second UE for handling messages other than control signalling messages.

According to another aspect, the object is achieved by providing a method performed by a network node, such as a radio network node or a device to device UE, for handling communication over a SL in a wireless communication network. The network node sends a configuration to a first UE to setup carrier aggregation over multiple carriers to a second UE. The configuration may comprise information for setting up multiple carriers that may or not may be used at the same time. The configuration triggers that one of the multiple carriers is selected to establish a primary carrier connection between the first UE and the second UE for handling control signalling messages, and one or more of the multiple carriers is selected as a secondary carrier connection between the first UE and the second UE for handling messages other than control signalling messages.

According to still another aspect, the object is achieved by providing a first UE, and a network node configured to perform the methods herein, respectively.

Thus, according to an aspect the object is achieved by providing a first UE for handling communication over a SL in a wireless communication network. The first UE is configured to receive a configuration from a network node to setup carrier aggregation over multiple carriers of a SL to a second UE. The first UE is further configured to select one of the multiple carriers, in the received configuration, to establish a primary carrier connection between the first UE and the second UE for handling control signalling messages, and one or more of the multiple carriers as a secondary carrier connection between the first UE and the second UE for handling messages other than control signalling messages.

Furthermore, according to another aspect the object is achieved by providing a network node for handling communication over a SL between UEs communicating in a wireless communication network. The network node is configured to send a configuration to a first UE to setup carrier aggregation over multiple carriers of a SL to a second UE, wherein the configuration triggers that one of the multiple carriers is selected to establish a primary carrier connection between the first UE and the second UE for handling control signalling messages, and one or more of the multiple carriers is selected as a secondary carrier connection between the first UE and the second UE for handling messages other than control signalling messages.

It is furthermore provided herein a computer program product comprising instructions, which, when executed on at least one processor, cause the at least one processor to carry out any of the methods herein, as performed by the first UE or the network node, respectively. It is additionally provided herein a computer-readable storage medium, having stored thereon a computer program product comprising instructions which, when executed on at least one processor, cause the at least one processor to carry out any of the methods herein, as performed by the first UE or the network node, respectively.

Thus, embodiments herein disclose methods for a SL UE, also referred to as the first UE, and for the network node to configure properly carrier aggregation for sidelink communications. The methods may comprise one or more of the following steps:
SL UE may perform measurement(s) over interface PC5, i.e., SL, and may report them to the network node.
The network node sends a configuration to the UE to setup carrier aggregation and this configuration may comprise multiple carriers that may or not may be used at the same time.
The first UE may continue to monitor status of the carriers used for carrier aggregation and if some e.g., RLF event, happen, the first UE may change the current setup for carrier aggregation
   This may imply deactivating a failed carrier, release the failed carrier and setup a new carrier, change a secondary carrier to be the primary carrier, or detecting new carriers to be used for carrier aggregation.
The first UE may eventually inform the network node about the detected event e.g., RLF, and may ask to the network node to have a new or another configuration.

In addition, the first UE may decide to activate or deactivate the whole carrier aggregation feature in case the condition on the configured carrier is not good enough to use this feature.

Using the proposed mechanism, is it possible to properly setup carrier aggregation for a SL UE
It becomes feasible to activate or deactivate a SL carrier among all configured SL carriers
The first UE is able to achieve a good balance between power saving and QoS satisfaction of services.

Thus, embodiments herein are handling communication between UEs over a SL in a resource efficient manner resulting in an improved performance of the wireless communication network.

### BRIEF DESCRIPTION OF THE DRAWINGS

Embodiments will now be described in more detail in relation to the enclosed drawings, in which:

FIG. 1 shows a SL according to prior art;

FIG. 2 is a schematic overview depicting a wireless communication network according to embodiments herein;

FIG. 3 is a combined signalling scheme and flowchart according to embodiments herein;

FIG. 4 is a flow chart depicting a method in a first UE according to embodiments herein;

FIG. 5 is a flow chart depicting a method in a network node according to embodiments herein;

FIG. 6 is a block diagram depicting a first UE according to embodiments herein;

FIG. 7 is a block diagram depicting a network node according to embodiments herein;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10, 11, 12, and 13 are flowcharts illustrating methods implemented in a communication system including a host computer, a base station and a user equipment.

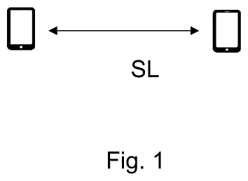

### DETAILED DESCRIPTION

Embodiments herein are described within the context of 3GPP NR radio technology (3GPP TS 38.300 V15.2.0 (2018 June)). It is understood that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

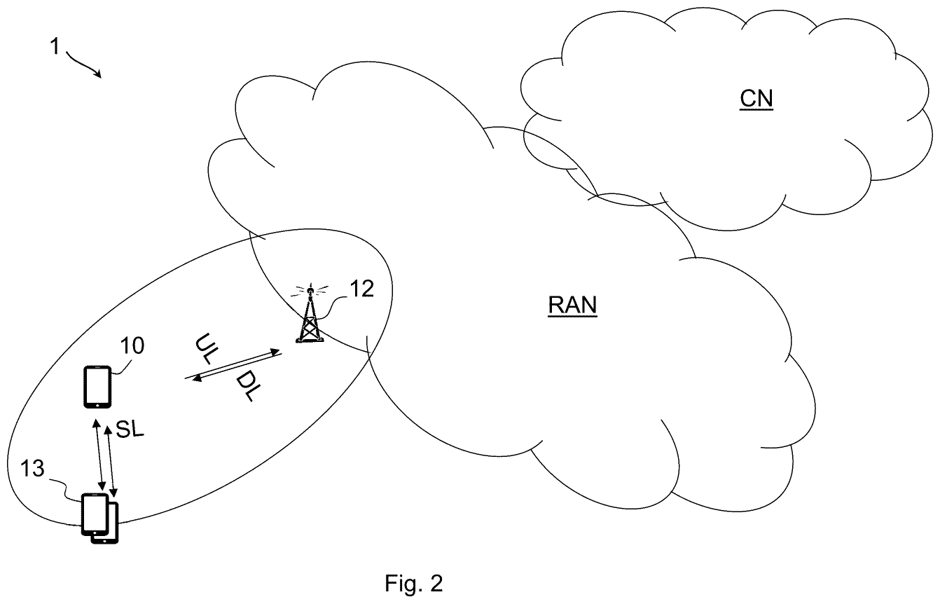

Embodiments herein relate to wireless communication networks in general. FIG. 2 is a schematic overview depicting a wireless communication network 1. The wireless communication network 1 comprises one or more RANs and one or more CNs. The wireless communication network 1 may use one or a number of different technologies, such as Wi-Fi, LTE, LTE-Advanced, 5G, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the wireless communication network 1, wireless devices, e.g., a first UE 10 also denoted as a transmitter UE 10 or just the SL UE, such as a mobile station, a non-access point (non-AP) STA, a STA, an internet of things (loT) capable device, a user equipment and/or a wireless terminal, communicate via one or more Access Networks (AN), e.g. RAN, to one or more CNs. It should be understood by the skilled in the art that “UE” is a non-limiting term which means any terminal, wireless communication terminal, user equipment, Machine Type Communication (MTC) device, Device to Device (D2D) terminal, loT device, or node e.g. smart phone, laptop, mobile phone, sensor, relay, mobile tablets or even a small base station capable of communicating using radio communication with a network node within an area served by the network node.

The wireless communication network 1 comprises a radio network node 12 providing radio coverage over a geographical area, a first service area, of a radio access technology (RAT), such as LTE, Wi-Fi, WiMAX or similar. The radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the radio network node 12 depending e.g. on the radio access technology and terminology used. The radio network node 12 may alternatively or additionally be a controller node or a packet processing node such as a radio controller node or similar. It should be noted that a service area may be denoted as cell, beam, beam group, or similar, to define an area of radio coverage.

The radio network node 12 may be referred to as a serving network node wherein the first service area may be referred to as a serving cell or primary cell, and the serving network node communicates with the UEs in form of DL transmissions to the UEs and UL transmissions from the UEs. The wireless communication network 1 further comprises one or more second UEs 13, also referred to as a requesting, receiving or receiver UE, communicating with the first UE 10 over a SL. The one or more second UEs 13, may also simply be referred to as the second UE 13. The first UE 10 may be referred to as transmitting or transmitter UE 10. The UEs, such as e.g., the first UE 10 and the second UE 13, may be configured with multiple SL carriers between one another or other UEs.

Embodiments herein relate to communication over a path between the first and second UE using resources, also denoted as a sidelink (SL). The embodiments are also applicable to other scenarios including UE to network relay or UE to UE relay where the link between first UE 10 and second UE 13 may be based on LTE sidelink or NR sidelink. The connection between the first UE 10 and the second UE 13 is also not limited to an LTE/NR SL, and a SL using any short-range communication technology such as Wi-Fi, Bluetooth, is equally applicable. In the below embodiments, any grant issued by the radio network node 12 is for a SL transmission between two UEs, e.g., the first UE 10 and the second UE 13.

According to embodiments herein multiple SL carriers may be configured between the first UE 10 and the second UE 13. A network node such as the radio network node 12 or the second UE 13 transmits a configuration to one or more UEs such as the first UE 10, wherein the configuration is for setting up carrier aggregation over multiple carriers of a SL between the first UE 10 and a second UE 13. The multiple carriers may or not may be used at the same time.

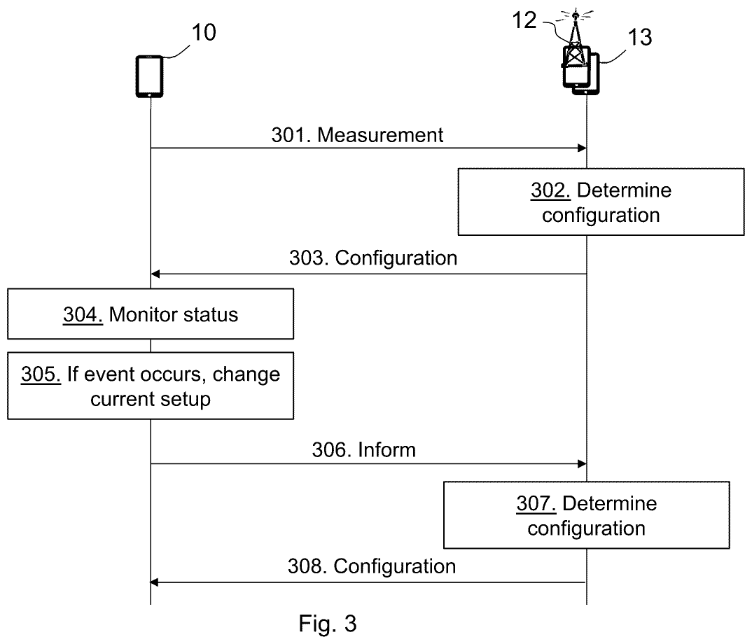

Note that, in a general scenario, the term “radio network node” may be substituted with “transmission point”. Distinction between the transmission points (TPs) may typically be based on cell reference signals (CRS) or different synchronization signals transmitted. Several TPs may be logically connected to the same radio network node, but, if they are geographically separated or are pointing in different propagation directions, the TPs may be subject to the same mobility issues as different radio network nodes. In subsequent sections, the terms “radio network node” and “TP” may be thought of as interchangeable. FIG. 3 is a combined flowchart and signalling scheme according to embodiments herein. The actions may be performed in any suitable order.

Action 301. The first UE 10 may perform measurement(s) over PC5, i.e., a SL, and may report the measurement(s) to the radio network node 12 or the second UE 13.

Action 302. The radio network node 12 or the second UE 13 may determine configuration for carrier aggregation based on the measurement(s) reported.

Action 303. The radio network node 12 or the second UE 13 sends the determined configuration to the first UE 10 to setup carrier aggregation over multiple carriers of a SL to one or more second UEs. The configuration may comprise information of which one or more carriers are part of the multiple carriers, e.g., identifiers or other indication of the multiple carriers. The configuration may comprise information for setting up multiple carriers that may or not may be used at the same time. The information may e.g., comprise information of which respective carriers and/or set of carriers may concurrently be used as other respective carriers and/or other sets of carriers. One of the multiple carriers is selected, by the first UE 10, to establish a primary carrier connection between the first UE 10 and the second UE 13 for handling control signalling messages, or at least control signalling messages, and one or more of the multiple carriers is selected as a secondary carrier connection between the first UE 10 and the second UE 13 for not handling control signalling messages, i.e., handling messages other than control signalling messages.

Action 304. The first UE 10 may further monitor statuses of the multiple carriers used for carrier aggregation.

Action 305. If an event occurs such as, e.g., RLF event, the first UE 10 may change the current setup for carrier aggregation. This may imply deactivating a failed carrier, releasing the failed carrier and setting-up a new one, changing a secondary carrier to be the primary carrier, and/or detecting new carriers to be used for carrier aggregation.

Action 306. The first UE 10 may inform the radio network node 12 or the second UE 13 about the detected event e.g., RLF, and request a new configuration from the radio network node 12.

Action 307. The radio network node 12 or the second UE 13 may receive the request and determine another configuration.

Action 308. The radio network node 12 or the second UE 13 may then transmit the other configuration to the first UE 10.

The methods and solutions disclosed herein, are referring to the NR RAT but may be applied also to LTE RAT and any other RAT enabling the direct transmission between two (or more) nearby UEs without any loss of meaning.

Methods described in the following embodiments are applicable to SL UEs with SL unicast transmission, such as the first UE 10 and the second UE 13.

A SL UE, e.g., the first UE 10, is configured with SL CA towards a peer UE, e.g., the second UE 13. This means that the first UE 10 is configured with multiple SL carriers for its SL transmissions or receptions. Thus, the first UE 10 may aggregate these SL carriers together for its SL transmissions or receptions. The first UE 10 may thus be able to perform transmissions or receptions according to at least one of the following modes:
The first UE 10 may only use one of the SL carriers to perform SL transmission or reception.
The first UE 10 may use two or more SL carriers of the configured SL carriers simultaneously to perform SL transmission or reception. A transmission or reception on a SL carrier may be fully or partially overlapping in time domain with another transmission or reception on another SL carrier.

The first UE 10 may thus maintain a SL, e.g., one PC5-RRC connection, for all configured SL carriers. The PC5-RRC connection is established on one or more of SL carriers.

In some embodiments where the first UE 10 is configured with SL CA towards the second UE 13, the carriers may be configured as the following:
one of the carriers is selected to carry/establish the PC5-RRC connection between the UE, e.g., the first UE 10, and the peer UE, e.g., the second UE 13. The carrier may be named as “primary carrier”. All RRC control signalling messages may be handled in the primary carrier. The primary carrier may handle other messages as well.
another carrier is named as “secondary carrier”, which is associated with the same PC5-RRC connection as the primary carrier, however, the secondary carrier does not handle any RRC control signalling. All RRC control signalling for any secondary carrier are handled in the primary carrier. The first UE 10 may be configured with one or multiple secondary carriers.
the primary carrier and any secondary carrier may be served in the same cell/radio network node or different cells/radio network nodes.

This embodiment and any following embodiment are not limited to any specific terminology. Any similar terms such as “master carrier” or “slave carrier” are interchangeably applied without losing any meaning.

The first UE 10 may perform measurements of neighbor/non-serving SL carriers and current active SL carriers/serving SL carriers in CA over the PC5 interface and may collect the measurements in a measurement report. This measurement report may then be sent to the second UE 13 or to the radio network node 12 or anyway to the network node that is responsible to configure the carrier aggregation at the SL UE. Also, the measurements obtained may be performed over one or multiple existing PC5 links or, as alternative, the measurements may be also obtained by measuring a SL discovery reference signal, e.g., sidelink discovery-reference signal received power (SD-RSRP), received by the first UE 10 in proximity during a discovery procedure. Once the measurements are performed by the first UE 10, the first UE 10 may include at least one of the following information into the measurement report:
Channel quality, e.g., RSRP, reference signal received quality (RSRQ), signal to interference plus noise ratio (SINR), reference signal strength indicator (RSSI), measured over every single carrier/frequency supported.
Channel congestion metrics, e.g., channel busy ratio (CBR), channel usage ratio (CR), channel occupancy (CO).
Channel quality measured on a certain band, where a band usually include a set of frequencies close to each other in the frequency domain.
Which carriers the first UE 10 has measured, and this may be order from the strongest, in terms of signal strength, to the weakest.
The location of the first UE 10 in the moment a measurement has been taken for a certain carrier.
Mobility information about the first UE 10, e.g., speed, acceleration, direction, mobility pattern.
Power used to perform the measurements on every single carrier.

As an additional embodiment, the first UE 10 may send the measurement report to the second UE 13 or to the radio network node 12 or anyway to the network node that is responsible to configure the carrier aggregation at the first UE 10 when one (or more) of the following criteria (referred to as “events” in the measurement configuration terminology) are fulfilled for example:
The measured quality of the primary carrier is below one threshold while the best measured non serving SL carrier quality exceeds another threshold.
The measured quality of a secondary carrier is below one threshold while the best measured non serving SL carrier quality exceeds another threshold.
The measured quality of the primary carrier is below one threshold while a measured non serving SL carrier quality exceeds another threshold.
The measured quality of a secondary carrier is below one threshold while a measured non serving SL carrier quality exceeds another threshold.
The measured quality of a secondary carrier is better than that of the primary carrier. Better as used herein may be with respect to a predefined condition or a predefined function.
The measured quality of the best secondary carrier is better than that of the primary carrier. Better as used herein may be with respect to a predefined condition or a predefined function.
The measured quality of the primary carrier is below one threshold while the best measured secondary SL carrier quality exceeds another threshold.

The network node, e.g., the second UE 13 or the radio network node 12, that receives the measurement report from the first UE 10, may decide on whether to configure carrier aggregation to the first UE 10. If this is the case, when sending the configuration for carrier aggregation to the first UE 10, the configuration comprises at least one, or a combination, of the following information:
Which carriers the first UE 10 are allowed to use for carrier aggregation. Each carrier may be identified by an identity (ID).
The maximum number of carriers that the UE, e.g., the first UE 10, is allowed to use for carrier aggregation.
Indicators about which carriers may act as “primary carrier” and which carriers may act as “secondary carrier”.
Indicators about which carrier is the primary carrier and which ones are the secondary carriers.
An indication on whether the SL, e.g., the PC5-RRC link, should only be setup on the primary carrier, if it can be setup to the primary carrier and a subset of secondary carrier, or if it can be setup on the primary carrier and all the secondary carriers.
Which carriers are in “active” state and which carriers are in “deactivated” state. With “active” state it means that the first UE 10 may start to use these carriers right away when configuring CA. On the contrary, with “deactivated” state the first UE 10 may configure these carriers for carrier aggregation but cannot have an active transmission or reception on these unless there is an indication or a certain event that make their status to switch from “deactivate” to “active”.

As an additional embodiment, the configuration may comprise at least one of the following:
A secondary carrier replaces the serving primary carrier to be the new primary carrier. Meanwhile the old primary carrier may operate as a secondary carrier or be removed, i.e., operating as neither as the primary carrier nor a secondary carrier;
A non-serving carrier replaces the serving primary carrier to be the new primary carrier;
A non-serving carrier replaces a secondary primary carrier to be the new secondary carrier;
A non-serving carrier is added to be a new secondary carrier;
A secondary carrier is removed i.e., not operating as the secondary carrier;
Deactivate and reconfigure/release carrier aggregation and select or determine to transmit on a single carrier, or vice versa.

Given the set of carriers that may be used for carrier aggregation over SL, how to choose which carrier is the primary carrier and which other carriers are the secondary carriers, may be done according to one (or a combination) of the following criteria:
The primary carrier is the carrier with the strongest channel quality of the measured channel qualities based on the measurements performed by the first UE 10. The rest of the secondary carriers may be selected by following the same rule, in descendent order by following the channel quality, or by considering in which frequency they are operating, i.e., from higher frequency to lower of vice versa.
The primary carrier is the carrier that has the lowest frequency. This is because that lower the frequency is the more robust, to the obstacle or pathloss, the connection is. The rest of the secondary carriers may be selected by following the same rule, i.e., from higher frequency to lower of vice versa, or by considering their channel quality.
The primary carrier is the carrier that has the highest frequency. This is because the higher the frequency is the more throughput may be achieved. The rest of the secondary carriers may be selected by following the same rule, i.e., from higher frequency to lower of vice versa, or by considering their channel quality.
The primary carrier is selected based on the geographical location of the first UE 10. Meaning that if the first UE 10 moves, channel condition may vary for all the carriers and the first UE 10 may need to switch primary carrier and secondary carrier between one carrier and another carrier.

The selection of the carriers on whether which carrier is the primary carrier, and which one is the secondary carrier may be static, semi-static, or dynamic.

If the selection is static, which carriers are configured for carrier aggregation and which carriers are configured to be primary carrier and which ones to be secondary carriers may be carried by the configuration itself and does not change.

If the selection is semi-static, which carriers are configured for carrier aggregation and which carriers are configured to be primary carrier and which ones to be secondary carriers may be carried by the configuration but the allocation of which is the primary carrier and which are the secondary carriers may be changed in a separate configuration. This may happen by an indication received from the radio network node 12, by an indication received from the second UE 13 or via a decision by the first UE 10 itself. The decision to change primary and secondary carriers may be done based on a measurement performed, or any order information known at the radio network node 12 or the second UE 13. Alternatively, the first UE 10 may also send an indication to the radio network node 12 or the second UE 13 to receive a switching command on which carrier should be used as primary carrier and which carriers should be used as secondary carriers.

If the selection is dynamic, the initial setup on which carriers are configured for carrier aggregation and which carriers are configured to be primary carrier and which ones to be secondary carriers may be carried by the configuration. However, the primary and secondary carrier may be switched dynamically based e.g., on the mobility of the first UE 10, on the channel measurements, on the geographical location of the first UE 10. Also in this case, the switching command may be received by an indication received from the radio network node 12, by an indication received from the second UE 13 or via a decision by the first UE 10 itself. Alternatively, the first UE 10 may also send an indication to the radio network node 12 or second UE 13 to receive a switching command on which carrier should be used as primary carrier and which carriers should be used as secondary carriers.

For any one of the above options, the first UE 10 may send the signalling to the radio network node 12 or the second UE 13 via at least one of the following signalling alternatives

Alt. 1: dedicated RRC signalling, which may be an existing RRC signalling or a new RRC signalling.

Alt. 2: MAC CE based signalling, which may be an existing MAC CE or a new MAC CE for indicating that the UE has declared/detected SL RLF.

Alt. 3: the UE initiates a random access channel (RACH) procedure to carry the signalling.

A 4-step random access (RA) may be triggered to carry the signalling.

In an example, Msg1 is used to carry the signalling. A dedicated preamble or dedicated RACH occasions may be allocated to the first UE 10 for indicating the above signalling information.

In an example, Msg3 is extended to carry the signalling information. In Msg3, the UE MAC entity adds an indicator indicating the above signalling information. The indicator may be a field in the MAC subheader or carried in a MAC CE.

A 2-step RA may be triggered to carry the signalling. A dedicated preamble or dedicated RACH occasions or dedicated physical uplink shared channel (PUSCH) occasions/resources may be allocated to the UE for indicating the signalling information. Alternatively, indicators may be included in MsgA payload. The indicator may be a field in the MAC subheader or carried in a MAC CE.

Alternatively, an RRC message, partly or fully, may be included in a RACH message, which includes the above signalling information from the UE.

Alt. 4: the first UE 10 initiates a physical uplink control channel (PUCCH) transmission for indicting the signalling information. Separate dedicated PUCCH resources may be configured accordingly.

Alt. 5: the first UE 10 initiates a configured grant-based transmission for carrying the signalling. Separate dedicated configured grant resources may be configured accordingly. Alternatively, the signalling information may be included in the configured grant uplink control information (CG-UCI).

Alt. 6: the first UE 10 initiates a sounding reference signal (SRS) transmission for indicting signalling information. Separate dedicated SRS resources may be configured accordingly.

Specifically, as an additional example to Alt. 4 and Alt. 5, the first UE 10 may transmit the signalling in the PUCCH-UCI which may be carried in the PUCCH or multiplexed with PUSCH.

Reselecting the primary carrier and the secondary carriers may be performed by the first UE 10 or the second UE 13 via a prediction. This means that the first UE 10 or the second UE 13 “predicts” when a failure over one of multiple carriers is likely to happen, and the predicting UE, such as the first UE 10, may inform the companion UE, such as the second UE 13, about this. Alternatively, the failure monitoring over SL may be performed by the first UE 10 or the second UE 13 via an early failure detection. This means that one or more criteria used for RLF detection are compared with one or more, more stringent, thresholds so that when the failure is detected, the carrier/radio link has not yet failed but it is going to fail soon.

Further, if the triggering for how to reselect the primary carrier and the secondary carriers is done based on a prediction by the first UE 10 and/or the second UE 13, the failure prediction over the carriers used for carrier aggregation may be based on a machine learning (ML) model in the first/second UE or any other mathematical model that may be used for predicting a certain event or behavior. The ML model may be sent from the radio network node 12 to the first/second UE and may be trained either by the radio network node 12 and/or the first/second UE. Alternatively, the ML model may be sent by the first UE to the second UE, or vice versa, and may be trained by either the first UE 10 or the second UE 13. Yet, the ML model may be decided by the first/second UE itself (meaning that is the UE who decide which model to use for the prediction).

An ML model may be used for the failure detection prediction over the carriers used for carrier aggregation, the first UE 10 may be configured, by the network, by a peer UE, or by its pre-configured internal model, with a time window parameter that indicates how much time in advance the first UE 10 should trigger the failure recovery action based on the failure prediction e.g. if timer window is 10 seconds, the first/second UE reports a predicted failure detection or trigger failure recovery when it is about to happen within 10 seconds, for that the first/second UE may maintain its own machine learning models for failure detection prediction over time depending on its conditions such as configurations and its own traffic. In another example, the first/second UE reports the predicted failure detection and indicates to the companion UE within how much time the RLF is going to happen after the time the first/second UE has triggered the report the companion UE receives. Alternatively, the first/second UE reports the predicted failure detection and indicates to the network within how much time the RLF is going to happen after the time the first/second UE has triggered the report the network receives.

If the first/second UE has its own ML model and it receives also one from the network or a companion UE, the first/second UE chooses to use one or the other ML model according to an explicit indication received by the network or the companion UE. Yet, in another embodiment, if the first/second UE has its own ML model and it receives also one from the network or companion UE, the reception of a ML model from the network is an implicit indication that the first/second UE shall use by default the one received by the network. Alternatively, the first/second UE chooses to use one or the other ML model according to its own implementation or pre-configuration stated in the specification.

The network node or another UE sends to the first/second UE an ML model that the first/second UE should use to predict a failure. When sending this ML model, the network or the UE may include at least one (or a combination) of the following:
The level of accuracy the prediction should have.
For how long the ML model should be used/trained by the first/second UE to predict a possible carrier/radio link failure, e.g., RLF.
Whether the first/second UE should report the accuracy of the prediction, if this accuracy is not configured by the network, another UE, or the model itself.
How early the first/second UE should report the predicted failure. E.g., if the first/second UE predicts that a failure is going to happen in 10 second, the network or the UE may configure the first/second UE to report the predicted failure within 5 second before the carrier/radio link failure, e.g., RLF, is going to happen.
Whether the first/second UE should report the expected duration of the carrier/radio link failure.

Further, the network node or another UE may send an explicit indication to the first/second UE just to tell the sidelink/peer UE that the ML model sent by the network or another UE should be used. Alternatively, the network node or another UE may send an explicit indication to the first/second UE to tell that the first/second UE may use its internal ML model (if it has any) for the prediction of the carrier/radio link failure detection.

Which option, out of the options described above, the first/second UE should use may be decided by the radio network node 12 and communicated to the first/second UE via dedicated RRC signalling or via system information. As an alternative, which option the first UE 10 should use is configured by the second UE 13 or pre-configured, hard-coded in the spec.

For any of the above embodiments, the signalling alternatives described will include at least one of the below

For signalling between the first UE 10 and the network node:
RRC signalling
MAC CE
Control protocol data unit (PDU) of a protocol layer, e.g., Service Data Adaption Protocol (SDAP), Packet Data Convergence Protocol (PDCP), radio link control (RLC) or an adaptation layer in case of SL relay.
L1 signalling on channels such as PRACH, PUCCH, physical downlink control channel (PDCCH), common control channel (CCCH)

For signalling between UEs:
RRC signalling, e.g., PC5-RRC
PC5-S signalling
Discovery signalling
MAC CE
Control PDU of a protocol layer, e.g., SDAP, PDCP, RLC or an adaptation layer in case of SL relay,
L1 signalling on channels such as PSSCH, PSCCH, or PSFCH.

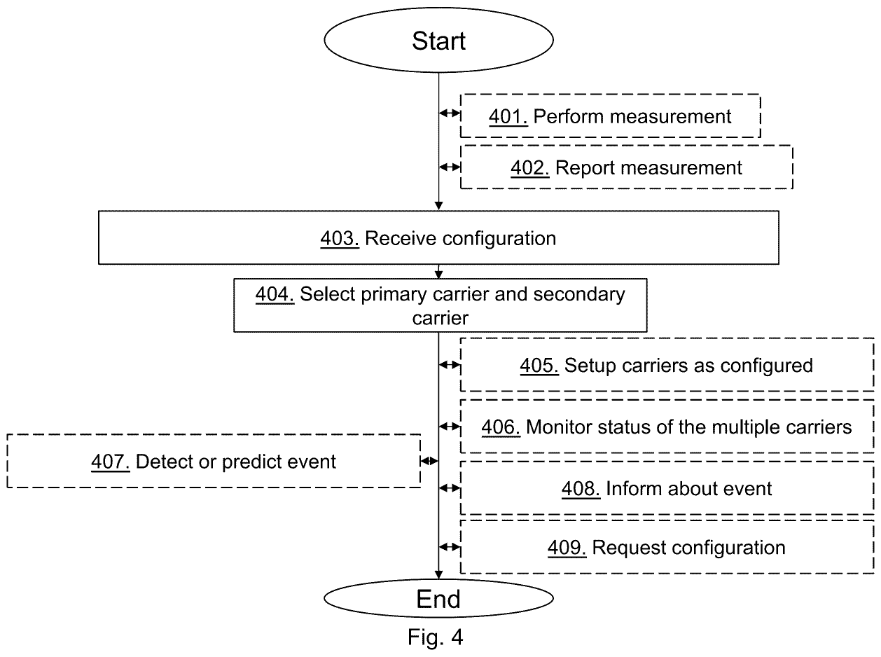

The method actions performed by the first UE 10 for handling communication over the SL in the wireless communication network 1 according to embodiments will now be described with reference to a flowchart depicted in FIG. 4. The actions do not have to be taken in the order stated below, but may be taken in any suitable order. Actions performed in some embodiments are marked with dashed boxes.

Action 401. The first UE 10 may perform one or more measurements over the SL between the first UE 10 and the second UE 13, i.e., over the PC5 interface.

Action 402. The first UE 10 may report the one or more measurements to a network node such as the radio network node 12 or the second UE 13.

Action 403. The first UE 10 receives the configuration from the network node to setup carrier aggregation over multiple carriers of a SL to the second UE 13. The configuration may comprise information of which one or more carriers are part of the multiple carriers, e.g., identifiers or other indication of the multiple carriers. The configuration triggers the selection. The configuration may comprise information for setting up multiple carriers that may or not may be used at the same time. The information may e.g., comprise information of which respective carriers and/or set of carriers may concurrently be used as other respective carriers and/or other sets of carriers.

Action 404. The first UE selects one of the multiple carriers, in the received configuration, to establish a primary carrier connection between the first UE 10 and the second UE 13 for handling control signalling messages, and one or more of the multiple carriers as a secondary carrier connection between the first UE 10 and the second UE for handling messages other than control signalling messages, i.e., not handling control signalling messages. The SL may comprise a PC5-RRC connection comprising the primary carrier connection. The selection may be indicated in the received configuration or selected by the first UE 10 based on one or more criteria. The first UE may select the one of the multiple carriers to establish the primary carrier connection, and the one or more of the multiple carriers to establish the secondary carrier connection based on the one or more criteria. The one or more criteria may comprise:
The primary carrier is the carrier with the strongest channel quality based on the measurements performed by the first UE 10. The rest of the secondary carriers may be selected by following the same rule (in descendent order by following the channel quality) or by considering in which frequency they are operating (i.e., from higher frequency to lower of vice versa).
The primary carrier is the carrier that has the lowest frequency. This is because that lower the frequency is the more robust (to the obstacle or pathloss) the connection is. The rest of the secondary carriers may be selected by following the same rule (i.e., from lower frequency to higher or vice versa) or by considering their channel quality.
The primary carrier is the carrier that has the highest frequency. This is because the higher the frequency is the more throughput may be achieved. The rest of the secondary carriers may be selected by following the same rule, i.e., from higher frequency to lower or vice versa, or by considering their channel quality.
The primary carrier is selected based on the geographical location of the first UE 10. Meaning that if the first UE 10 moves, channel condition may vary for all the carriers and the first UE 10 may need to switch primary carrier and secondary carrier between one carrier and another carrier.

Action 405. The first UE 10 may setup the multiple carriers for carrier aggregation according to the received configuration and selection.

Action 406. The first UE 10 may monitor status of at least one carrier out of the multiple carriers used for carrier aggregation.

Action 407. The first UE 10 may detect an event or predict an event to occur taking the monitored status into account. The prediction may be based on a ML model. If the event occurs such as, e.g., RLF event, the first UE 10 may change the current setup for carrier aggregation. This may imply that the first UE 10 may deactivate the failed carrier, release the failed carrier and setup a new one, change a secondary carrier to be the primary carrier, and/or detect new carriers to be used for carrier aggregation. The first UE 10 may predict when a failure will occur. With the proviso that the event occurs or is predicted the first UE 10 may change configuration of one or more of the multiple carriers.

Action 408. The first UE 10 may inform the network node about the detected event, e.g., RLF, or prediction when the event will occur.

Action 409. The first UE 10 may request a new or another configuration from the network node, e.g., in response to informing about the detected event, e.g., RLF, or prediction when the event will occur.

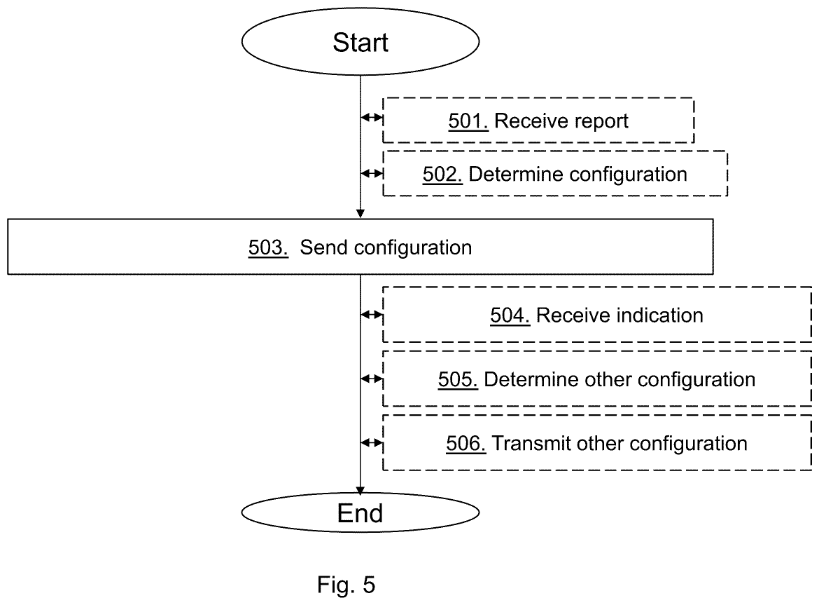

The method actions performed by the network node such as the radio network node 12 or the second UE 13, for handling communication over the SL between UEs communicating in the wireless communication network 1 according to embodiments of the present disclosure will now be described with reference to a flowchart depicted in FIG. 5. The actions do not have to be taken in the order stated below, but may be taken in any suitable order. Actions performed in some embodiments are marked with dashed boxes.

Action 501. The network node may receive the report of the one or more measurements from the first UE 10.

Action 502. The network node may determine configuration for carrier aggregation based on the report of the one or more measurements. The configuration may comprise information of which one or more carriers are part of the multiple carriers, e.g., identifiers or other indication of the multiple carriers. One of the multiple carriers, in the configuration, is selected to establish the primary carrier connection between the first UE 10 and the second UE 13 for handling control signalling messages, and one or more of the multiple carriers is selected as the secondary carrier connection between the first UE 10 and the second UE 13 for handling messages other than control signalling messages, i.e., not handling control signalling messages. The network node may select which carrier is the primary carrier and which other carriers are the secondary carriers based on the one or more criteria.

Action 503. The network node sends the configuration to the first UE to setup carrier aggregation over multiple carriers of a SL to the second UE 13. The configuration may comprise information for setting up multiple carriers that may or not may be used at the same time. The information may e.g., comprise information of which respective carriers and/or set of carriers may concurrently be used as other respective carriers and/or other sets of carriers. The configuration triggers that one of the multiple carriers, in the configuration, is selected to establish the primary carrier connection between the first UE 10 and the second UE 13 for handling control signalling messages, and one or more of the multiple carriers is selected as the secondary carrier connection between the first UE 10 and the second UE 13 for handling messages other than control signalling messages, i.e., not handling control signalling messages. Thus, the network node configures the first UE by sending the configuration to setup carrier aggregation of a SL.

Action 504. The network node may receive an indication that an event has been detected or is predicted. The network node may receive the request for another configuration.

Action 505. The network node may determine another configuration.

Action 506. The network node may then transmit the determined other configuration to the first UE 10.

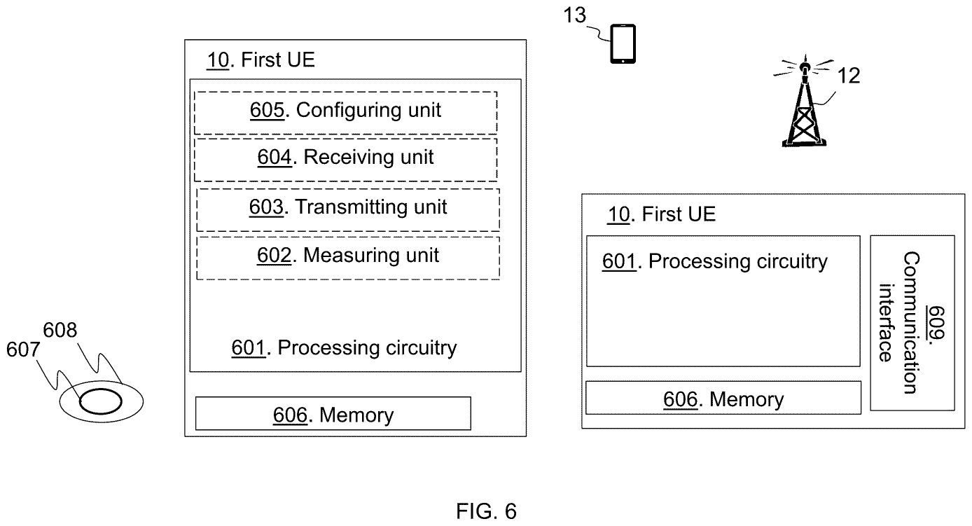

FIG. 6 is a block diagram depicting the first UE 10 for handling communication over the SL in the wireless communication network according to embodiments herein.

The first UE 10 may comprise processing circuitry 601, e.g. one or more processors, configured to perform the methods herein.

The first UE 10 may comprise a measuring unit 602. The first UE 10, the processing circuitry 601, and/or the measuring unit 602 may be configured to perform one or more measurements over the SL between the first UE 10 and the second UE 13 such as over the PC5 interface.

The first UE 10 may comprise a transmitting unit 603, such as a transmitter or a transceiver. The first UE 10, the processing circuitry 601, and/or the transmitting unit 603 may be configured to transmit the indication or report of the one or more measurements.

The first UE 10 may comprise a receiving unit 604, such as a receiver or a transceiver. The first UE 10, the processing circuitry 601, and/or the receiving unit 604 is configured to receive the configuration from the network node to setup carrier aggregation over the multiple carriers to the second UE 13. The configuration may comprise information for setting up the multiple carriers that may or not may be used at the same time. One of the multiple carriers, in the received configuration, is selected to establish the primary carrier connection between the first UE 10 and the second UE 13 for handling control signalling messages, and one or more of the multiple carriers is selected as the secondary carrier connection between the first UE 10 and the second UE 13 for handling messages other than control signalling messages, i.e., not handling control signalling messages. The selection may be indicated in the configuration or selected by the first UE 10 based on the one or more criteria. the SL maty comprise a PC5-RRC connection comprising the primary carrier connection.

The first UE 10 may comprise a configuring unit 605. The first UE 10, the processing circuitry 601, and/or the configuring unit 605 is configured to select the one of the multiple carriers, in the received configuration, to establish the primary carrier connection between the first UE 10 and the second UE 13 for handling control signalling messages, and one or more of the multiple carriers as the secondary carrier connection between the first UE 10 and the second UE 13 for handling messages other than control signalling messages. The first UE 10, the processing circuitry 601, and/or the configuring unit 605 may be configured to select which carrier is the primary carrier and which other carriers are the secondary carriers based on the one or more criteria, i.e., configured to select the one of the multiple carriers to establish the primary carrier connection, and the one or more of the multiple carriers to establish the secondary carrier connection, based on the one or more criteria. The first UE 10, the processing circuitry 601, and/or the configuring unit 605 may be configured to setup the multiple carriers for carrier aggregation according to the received configuration.

The first UE 10, the processing circuitry 601, and/or the measuring unit 602 may be configured to monitor status of at least one carrier out of the multiple carriers used for carrier aggregation.

The first UE 10, the processing circuitry 601, and/or the measuring unit 602 may be configured to detect an event or predict an event to occur taking the monitored status into account.

If the event occurs such as, e.g., RLF event, the first UE 10, the processing circuitry 601, and/or the configuring unit 605 may be configured to change the current setup for carrier aggregation. This may imply that the first UE 10, the processing circuitry 601, and/or the configuring unit 605 may be configured to deactivate the failed carrier, release the failed carrier and setup a new one, change a secondary carrier to be the primary carrier, and/or detect new carriers to be used for carrier aggregation. The first UE 10, the processing circuitry 601, and/or the configuring unit 605 may be configured to predict when a failure will occur. With the proviso that, or if, the event occurs or is predicted the first UE 10, the processing circuitry 601, and/or the configuring unit 605 may be configured to change configuration of one or more of the multiple carriers.

The first UE 10, the processing circuitry 601, and/or the transmitting unit 603 may be configured to inform the network node about the detected event, e.g., RLF, or prediction when the event will occur, and to request a new or another configuration from the network node.

The first UE 10 further comprises a memory 606. The memory comprises one or more units to be used to store data on, such as indications, SL carriers, CSI information, requests, configuration, strengths or qualities, grants, indications, requests, commands, timers, applications to perform the methods disclosed herein when being executed, and similar. Thus, the first UE may comprise the processing circuitry and the memory, said memory comprising instructions executable by said processing circuitry whereby said first UE is operative to perform the methods herein. The first UE 10 comprises a communication interface 609 comprising e.g. one or more antennas.

The methods according to the embodiments described herein for the first UE 10 are respectively implemented by means of e.g. a computer program product 607 or a computer program, comprising instructions, i.e., software code portions, which, when executed on at least one processor, cause the at least one processor to carry out the actions described herein, as performed by the first UE 10. The computer program product 607 may be stored on a computer-readable storage medium 608, e.g. a universal serial bus (USB) stick, a disc, or similar. The computer-readable storage medium 608, having stored thereon the computer program product, may comprise the instructions which, when executed on at least one processor, cause the at least one processor to carry out the actions described herein, as performed by the first UE 10. In some embodiments, the computer-readable storage medium may be a non-transitory or a transitory computer-readable storage medium.

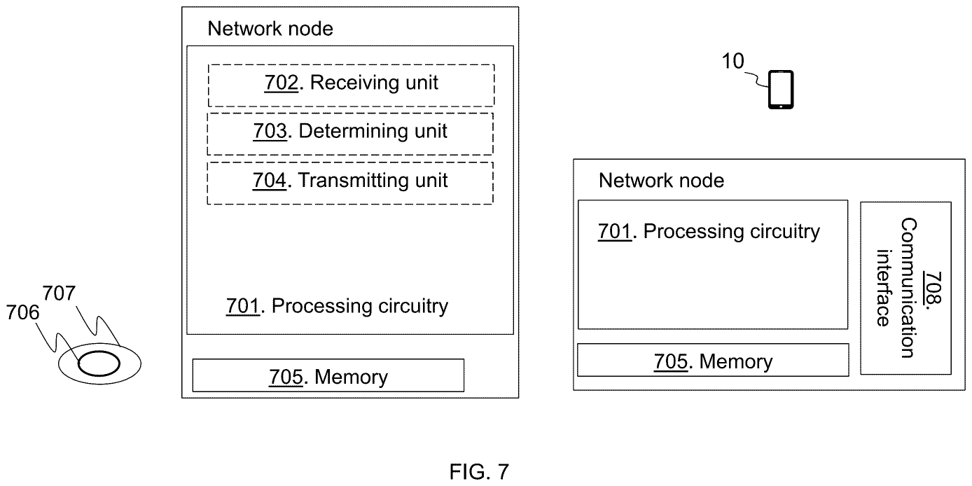

FIG. 7 is a block diagram depicting the network node such as the radio network node 12 or the second UE 13, in two embodiments, for handling communication over the SL in the wireless communication network.

The network node may comprise processing circuitry 701, e.g., one or more processors, configured to perform the methods herein.

The network node may comprise a receiving unit 702, e.g., a receiver or a transceiver. The network node, the processing circuitry 701 and/or the receiving unit 702 may be configured to receive the report of the one or more measurements from the first UE 10.

The network node may comprise a determining unit 703. The network node, the processing circuitry 701 and/or the determining unit 703 may be configured to determine the configuration for carrier aggregation based on the report of the one or more measurements.

The network node may comprise a transmitting unit 704, e.g., a transmitter or a transceiver. The network node, the processing circuitry 701 and/or the transmitting unit 704 is configured to send the configuration to the first UE 10 to setup carrier aggregation over multiple carriers of a SL to the second UE 13. The configuration triggers that one of the multiple carriers is selected to establish the primary carrier connection between the first UE 10 and the second UE 13 for handling control signalling messages, and one or more of the multiple carriers is selected as the secondary carrier connection between the first UE 10 and the second UE 13 for handling messages other than control signalling messages, i.e., not handling control signalling messages. The configuration may comprise information for setting up multiple carriers that may or not may be used at the same time.

The network node, the processing circuitry 701 and/or the receiving unit 702 may be configured to receive the indication that an event has been detected or is predicted. The network node, the processing circuitry 701 and/or the receiving unit 702 may be configured to receive the request for another configuration.

The network node, the processing circuitry 701 and/or the determining unit 703 may be configured to determine another configuration.

The network node, the processing circuitry 701 and/or the transmitting unit 704 may be configured to transmit the determined other configuration to the first UE 10.

The network node further comprises a memory 705. The memory comprises one or more units to be used to store data on, such as indications, CSI information, SL carrier information, configurations, strengths or qualities, grants, scheduling information, timers, applications to perform the methods disclosed herein when being executed, and similar. Thus, the network node may comprise the processing circuitry and the memory, said memory comprising instructions executable by said processing circuitry whereby said network node is operative to perform the methods herein. The network node comprises a communication interface 708 comprising, e.g., transmitter, receiver, transceiver and/or one or more antennas.

The methods according to the embodiments described herein for the network node are respectively implemented by means of, e.g., a computer program product 706 or a computer program product, comprising instructions, i.e., software code portions, which, when executed on at least one processor, cause the at least one processor to carry out the actions described herein, as performed by the network node. The computer program product 706 may be stored on a computer-readable storage medium 707, e.g., a USB stick, a disc or similar. The computer-readable storage medium 707, having stored thereon the computer program product, may comprise the instructions which, when executed on at least one processor, cause the at least one processor to carry out the actions described herein, as performed by the network node. In some embodiments, the computer-readable storage medium may be a non-transitory or transitory computer-readable storage medium.

In some embodiments a more general term “radio network node” is used and it may correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT), etc.

In some embodiments, the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals, e.g., data, e.g. LTE, LTE FDD/TDD, WCDMA/HSPA, GSM/GERAN, Wi Fi, WLAN, CDMA2000 etc.

As will be readily understood by those familiar with communications design, functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

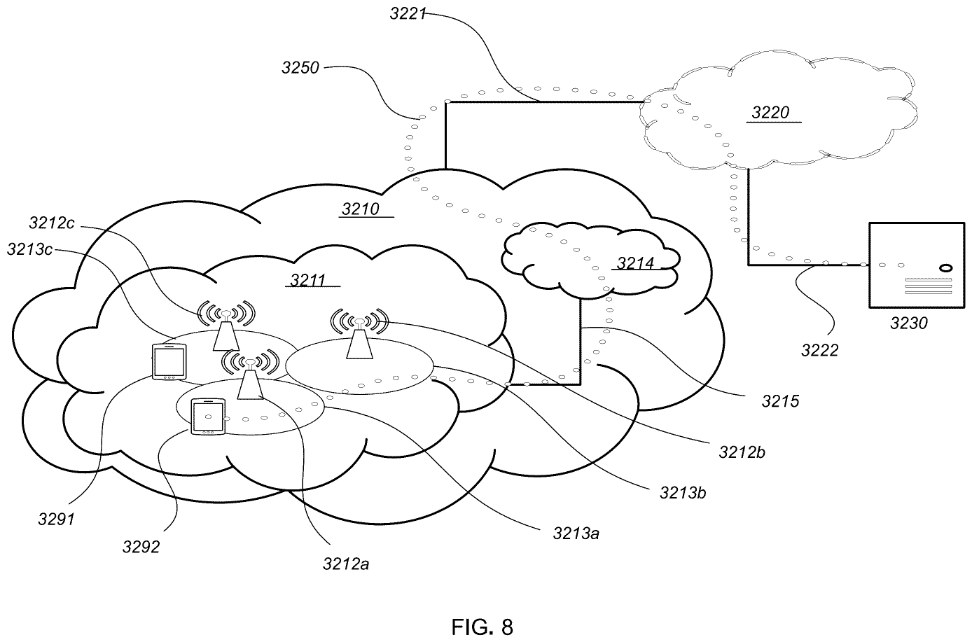

With reference to FIG. 8, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the first UE 10 and second UE 13, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

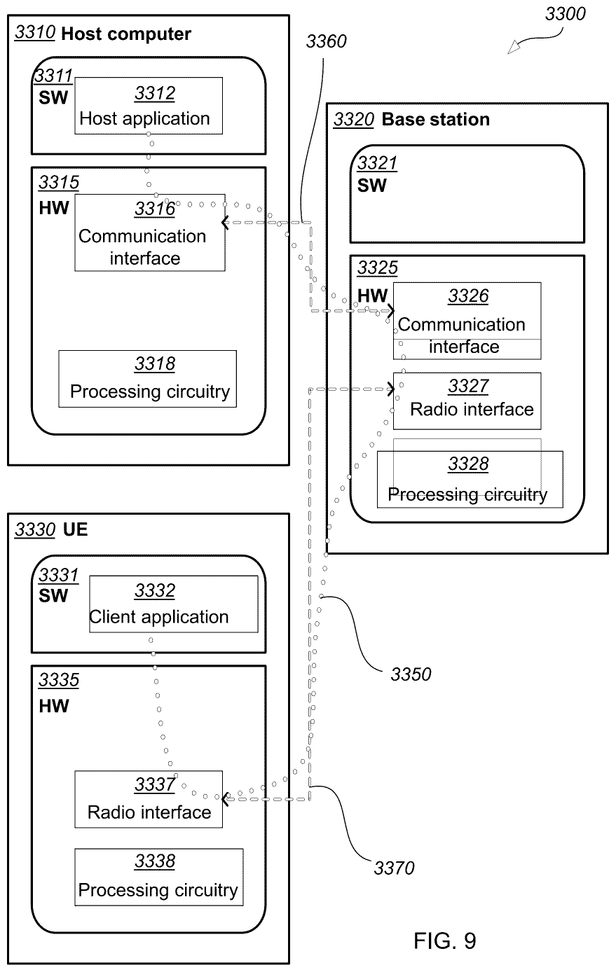

Example implementations, in accordance with an embodiment, of the UE, base station and host computer discussed in the preceding paragraphs will now be described with reference to FIG. 9. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 9) served by the base station 3320. The communication interface 3326 may be configured to facilitate a connection 3360 to the host computer 3310. The connection 3360 may be direct or it may pass through a core network (not shown in FIG. 9) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 9 may be identical to the host computer 3230, one of the base stations 3212a, 3212b, 3212c and one of the UEs 3291, 3292 of FIG. 8, respectively. This is to say, the inner workings of these entities may be as shown in FIG. 9 and independently, the surrounding network topology may be that of FIG. 8.

In FIG. 9, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since SLs of CA are handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc. ; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

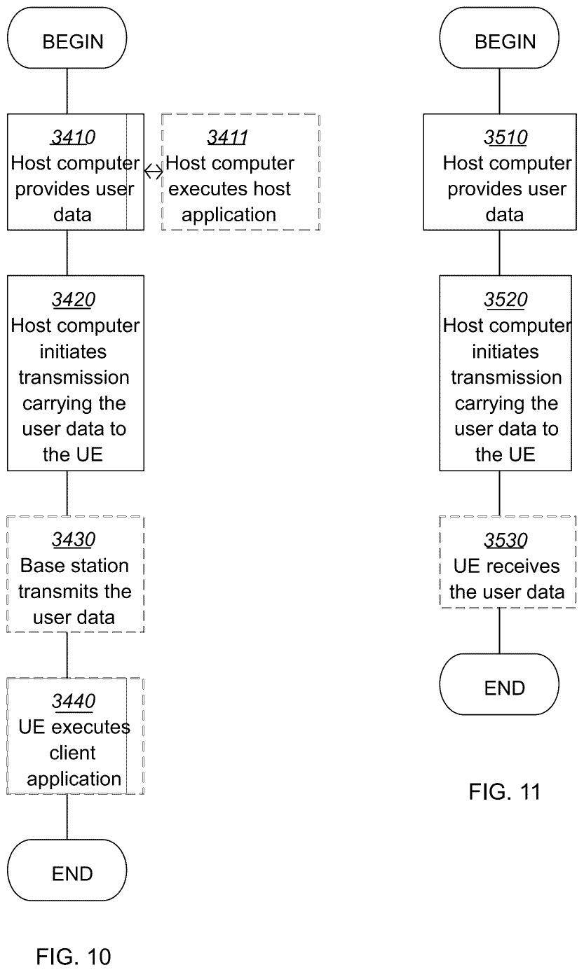

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

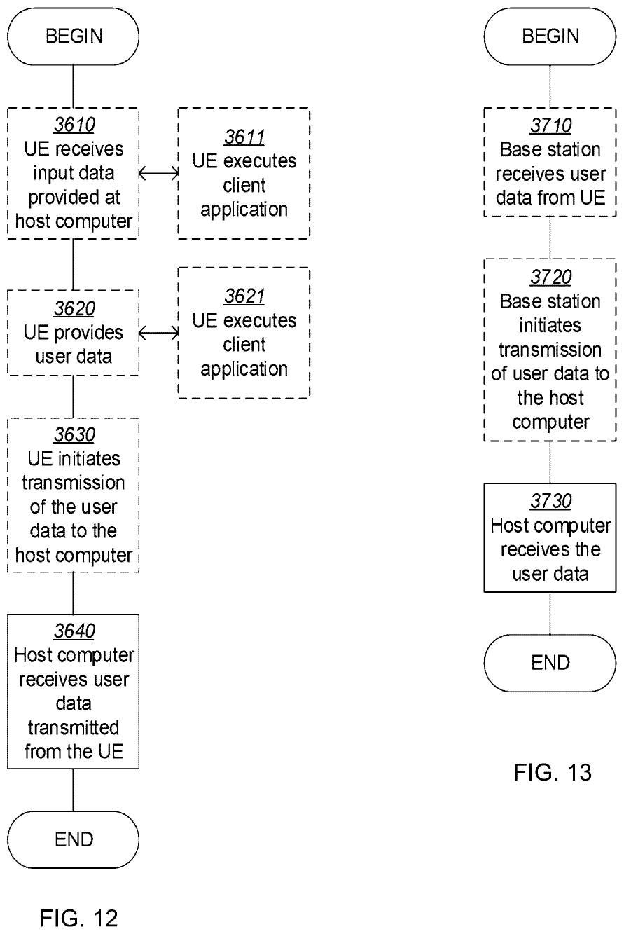

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations

BS Base Station
CAM Cooperative Awareness Message
CE Control Element
CN Core Network
CSI-RS Channel State Information Reference Signal
DM-RS Demodulation Reference Signal
DRX Discontinuous Reception
eNB e-Node B
gNB g-Node B
ID Identity
ITS Intelligent Transport Systems
L2 Layer 2
LCH Logical Channel
LCG Logical Channel Group
LTE Long Term Evolution
MAC Medium Access Control
NR New Radio
NW Network
PDU Protocol Data Unit
PHY Physical (layer)
PSBCH Physical Sidelink Broadcast Channel
PSCCH Physical Sidelink Control Channel
PSSCH Physical Sidelink Shared Channel
PT-RS Phase Tracking Reference Signal
RRC Radio Resource Control
RS Reference Signal
RX Reception, receiver
SA Scheduling Assignment
SL Sidelink
S-PSS Sidelink Primary Synchronization Signal
S-SSB Sidelink Synchronization Signal Block
S-SSS Sidelink Secondary Synchronization Signal
TX Transmission, transmitter
UE User Equipment
V2V Vehicle-to-Vehicle
V2X Vehicle-to-Anything

1. A method performed by a first user equipment, UE, for handling communication over a sidelink, SL, in a wireless communication network, the method comprising
receiving a configuration from a network node to setup carrier aggregation over multiple carriers of a SL to a second UE; and
selecting one of the multiple carriers, in the received configuration, to establish a primary carrier connection between the first UE and the second UE for handling control signaling messages, and one or more of the multiple carriers as a secondary carrier connection between the first UE and the second UE for handling messages other than control signaling messages.

2. The method according to claim 1, further comprising
performing one or more measurements over the sidelink between the first UE and the second UE.

3. The method according to claim 2, further comprising
reporting the one or more measurements to the network node or the second UE.

4. The method according to claim 1, wherein the SL comprises a PC5-radio resource control, RRC, connection comprising the primary carrier connection.

5. The method according to claim 1, wherein selecting the one of the multiple carriers to establish the primary carrier connection, and the one or more of the multiple carriers to establish the secondary carrier connection is based on one or more criteria.

6. The method according to claim 1, wherein the selection is indicated in the received configuration or selected by the first UE based on one or more criteria.

7. The method according to claim 1, further comprising
setting up the multiple carriers for carrier aggregation according to the received configuration and selection.

8. The method according to claim 1, further comprising
monitoring status of at least one carrier out of the multiple carriers used for carrier aggregation; and
detecting an event or predicting an event to occur taking the monitored status into account.

9. The method according to claim 8, further comprising, with the proviso that the event occurs or is predicted, changing configuration of one or more of the multiple carriers.

10. The method according to claim 8, further comprising
informing the network node about the detected event, or prediction when the event will occur, and
requesting another configuration from the network node.

11. A method performed by a network node for handling communication over a sidelink, SL, between user equipments, UE, communicating in a wireless communication network, the method comprising
sending a configuration to a first UE to setup carrier aggregation over multiple carriers of a SL to a second UE, wherein the configuration triggers that one of the multiple carriers is selected to establish a primary carrier connection between the first UE and the second UE for handling control signaling messages, and one or more of the multiple carriers is selected as a secondary carrier connection between the first UE and the second UE for handling messages other than control signaling messages.

12. The method according to claim 11, further comprising
receiving report of one or more measurements from the first UE; and
determining the configuration for carrier aggregation based on the report of the one or more measurements.

13. The method according to claim 12, wherein determining configuration comprises selecting which carrier is a primary carrier and which other carriers are secondary carriers based on one or more criteria.

14.-15. (canceled)

16. A first user equipment, UE, for handling communication over a sidelink, SL, in a wireless communication network, wherein the first UE is configured to:
receive a configuration from a network node to setup carrier aggregation over multiple carriers of a SL to a second UE; and
select one of the multiple carriers, in the received configuration, to establish a primary carrier connection between the first UE and the second UE for handling control signaling messages, and one or more of the multiple carriers as a secondary carrier connection between the first UE and the second UE for handling messages other than control signaling messages.

17. The first UE according to claim 16, wherein the first UE is configured to perform one or more measurements over the sidelink between the first UE and the second UE.

18.-25. (canceled)

26. A network node for handling communication over a sidelink, SL, between user equipments, UE, communicating in a wireless communication network, wherein the network node is configured to
send a configuration to a first UE to setup carrier aggregation over multiple carriers of a SL to a second UE, wherein the configuration triggers that one of the multiple carriers is selected to establish a primary carrier connection between the first UE and the second UE for handling control signalling messages, and one or more of the multiple carriers is selected as a secondary carrier connection between the first UE and the second UE for handling messages other than control signalling messages.

27. The network node according to claim 26, wherein the network node is configured to select which carrier is a primary carrier and which other carriers are secondary carriers based on one or more criteria.

28.-32. (canceled)
